(19) United States
(12) Patent Application Publication
(10) Pub. No.: US 2006/0256317 A1
(43) Pub. Date: Nov. 16, 2006

(54) RANGE FINDER

(75) Inventor: Wen-Hsin Liao, Ta Li City (TW)

Correspondence Address: NIKOLAI & MERSEREAU, P.A., 900 SECOND AVENUE SOUTH, SUITE 820, MINNEAPOLIS, MN, 55402, US

(73) Assignee: CHING LIN INDUSTRIAL CO., LTD., Ta Li City (TW)

(21) Appl. No.: 10/908,398

(22) Filed: May 10, 2005

(51) Int. Cl. G01C 3/08; G03B 13/00; G03B 15/02

(52) U.S. Cl. 356/4.01; 356/5.01

(57) ABSTRACT

A range finder is disclosed to include a housing, two spirit levels, a transceiver and a circuit board. The housing includes a first window defined therein, a second window defined therein and two fins formed thereon for contact with a first object. A phantom line, in which the centers of the windows lie, is perpendicular to a plane defined by the fins. The spirit levels are installed on the housing so that they are perpendicular to each other. The transceiver is installed in the housing. The transceiver can transmit laser to a second object through the first window. The transceiver can receive light reflected from the object. The circuit board is installed in the housing and electrically connected with the transceiver in order to receive data from the transceiver and determine the distance between the first and second objects based on the data.

### BACKGROUND OF INVENTION

1. Field of Invention

The present invention relates to a range finder and, more particularly, to a laser range finder.

2. Related Prior Art

Conventionally, in construction or interior decoration, measuring tapes are used to measure distances such as lengths, widths and heights. Measuring tapes are useful in small spaces only but useless in large spaces.

Range finders are used to measure distances in large spaces. Such a range finder 10 is disclosed in Taiwanese Patent Publication No. 385006. The range finder 10 includes a datum far infrared transmitter 11, a rotational far infrared transmitter 12, three meters 13, 14 and 15, a level 17 and a vertical level 18. To use the range finder 10, a measuring tape 19 is used to select from three predetermined distances, 2 m, 3 m and 5 m, from a wall. The range finder 10 is located at one of the pre-determined distances from the wall. The level 17 and the vertical level 18 are observed to determine a horizontal state. The datum far infrared transmitter 11 is used to project a datum T0 on the wall. The rotational far infrared transmitter 12 is used to project a dot on the wall so that the dot is aligned with the datum T0. The readings of the meters 13, 14 and 15 are set to zero. The rotational far infrared transmitter 12 is used to aim at a point T1. Now, the readings of the meters 13, 14 and 15 are used to determine the distance between the datum T0 and the point T1.

Several problems have been encountered in using the range finder 10. The meters 13, 14 and 15 all include three scales based on the distances, i.e., 2 m, 3 m and 5 m. When the range finder 10 is located at 2 m from the wall, the scales of the members 13, 14 and 15 based on 2 m are read to determine the distance. When the range finder 10 is located at 5 m from the wall, the scales of the members 13, 14 and 15 based on 5 m are read in order to determine the distance. However, in practice, it is often difficult to locate the range finder 10 exactly at 2 m, 3 m or 5 m from the wall so that the scales of the meters 13, 14 and 15 cannot be read to determine the distance precisely.

The rotational far infrared transmitter 12 is connected with three coaxial gears 40, 41 and 42. The meter 13 is connected with a gear 30. The gear 30 is engaged with the gear 42. The meter 14 is connected with a gear 31. The gear 31 is engaged with the gear 41. The meter 15 is connected with a gear 32. The gear 32 is engaged with the gear 40. However, errors often occur because of the gaps between the gears so that the distance cannot be determined precisely.

The present invention is therefore intended to obviate or at least alleviate the problems encountered in prior art.

### SUMMARY OF INVENTION

According to the present invention, a range finder is disclosed to include a housing, two spirit levels, a transceiver and a circuit board. The housing includes a first window defined therein, a second window defined therein and two fins formed thereon for contact with a first object. A phantom line, in which the centers of the windows lie, is perpendicular to a plane defined by the fins. The spirit levels are installed on the housing so that they are perpendicular to each other. The transceiver is installed in the housing. The transceiver can transmit laser to a second object through the first window. The transceiver can receive light reflected from the object. The circuit board is installed in the housing and electrically connected with the transceiver in order to receive data from the transceiver and determine the distance between the first and second objects based on the data.

An advantage of the range finder according to the present invention is its ability to determine the distance precisely in various environments.

Another advantage of the range finder according to the present invention is its ability to determine the distance for not including intermeshed gears.

Other advantages and novel features of the invention will become more apparent from the following detailed description in conjunction with the drawings.

### BRIEF DESCRIPTION OF DRAWINGS

The present invention will be described through detailed illustration of the preferred embodiment referring to the drawings.

FIG. 1 is a perspective view of a laser range finder according to the preferred embodiment of the present invention.

FIG. 2 is an exploded view of the laser range finder shown in FIG. 1.

FIG. 3 is a cross-sectional view of the laser range finder of FIG. 1.

FIG. 4 is a front view of the laser range finder of FIG. 1.

FIG. 5 is a side view of the laser range finder shown in FIG. 1 in an operational state.

FIGS. 6 and 7 are side views of the laser range finder shown in FIG. 1 in another operational state.

FIG. 8 is a side view of the laser range finder shown in FIG. 1 in another operational state.

### DETAILED DESCRIPTION OF PREFERRED EMBODIMENT

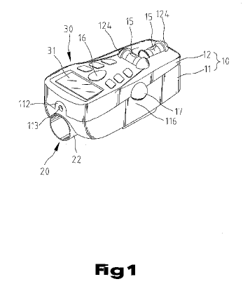

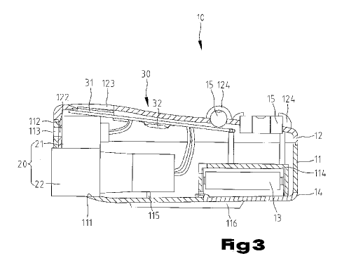

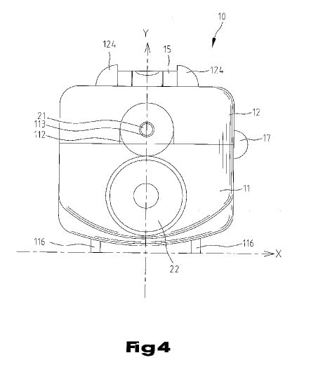

The drawings, FIGS. 1 through 8, show a range finder according to the preferred embodiment.

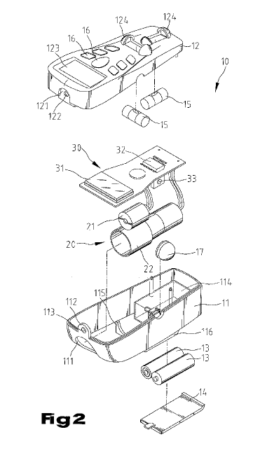

Referring to FIGS. 2 through 4, the range finder includes a housing 10, a transceiver 20 and a circuit board 30.

The housing 10 includes a box 11 and a panel 12. The box 11 includes a window 111 defined in an end, an ear 112 formed at the end, an aperture 113 defined in the ear 112, a battery chamber 114 formed on an internal side thereof for receiving two batteries 13, a seat 115 formed on the internal side thereof for supporting the transceiver 20 and two fins 116 formed on an external side thereof. The battery chamber 114 is open downwards, and can be closed by means of a cover 14. A phantom line, in which the centers of the apertures 111 and 113 lie, is perpendicular to a plane defined the fins 116.

The panel 12 includes a recess 121 defined in an end, an aperture 122 defined in the end, a window 123 defined therein near the end and two seats 124 formed thereon. Two spirit levels 15 are installed on the seats 124 so that they are perpendicular to each other. One of the spirit levels 15 is used to determine a horizontal position of the transceiver 20. The remaining spirit level 15 is used to determine a vertical position of the transceiver 20. A plurality of buttons 16 is installed on the panel 12. A button 17 is installed on a side of the housing 10.

The panel 12 is installed on the box 11. The recess 121 receives the ear 112. The aperture 122 is communicated with the aperture 113.

The transceiver 20 includes a transmitter 21 and a receiver 22. The transmitter 21 and the receiver 22 both include cylindrical profiles. The transmitter 21 and the receiver 22 are integrated with each other so that the axes thereof are perpendicular to each other. The transmitter 21 may include a laser diode (not shown) in order to transmit laser. Thus, a dot can be projected on an object by means of the laser. The transmitter 21 can receive light reflected from the object. The receiver 22 may include a signal-amplifying wave filter (not shown) in order to determine the distance between the dot and the range finder. Such laser diode and signal-amplifying wave filter are conventional and therefore will not be described in detail.

The receiver 22 is put on the seat 115. The receiver 22 is aligned with the window 111. The receiver 22 is aligned with the window 111 so that the receiver 22 can receive the reflected light. The transmitter 21 is aligned with the apertures 122 and 113 so that the laser can pass through the apertures 122 and 113.

The circuit board 30 includes a display 31, a microprocessor 32 and a switch 33. The circuit board 30 is electrically connected with the transceiver 20. The display 31 is used to show information. The microprocessor 32 is used to process data provided by means of the receiver 22. The switch 33 is used to turn the circuit board 30 on and off. The circuit board 30 is powered by means of the batteries 13. The circuit board 30 is electrically connected with the buttons 16 so that the latter can be operated to control the former.

The circuit board 30 is installed in the case 10. The display 31 is aligned with the window 123 so that it can be observed. The switch 33 is in contact with the button 17 so that the former can be operated through the latter.

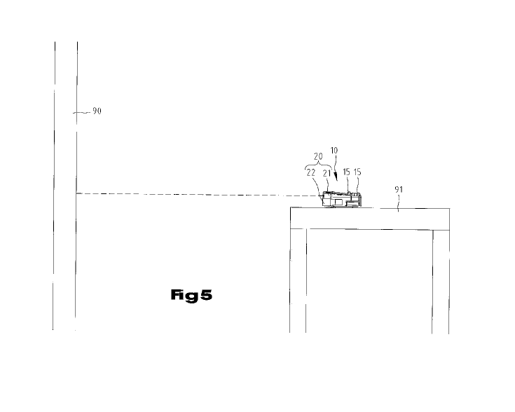

Referring to FIG. 5, the range finder is used to measure the distance between a wall 90 and an object 91. The range finder is put on the object 91. The position of the object 91 is adjusted while the spirit levels 15 are observed. The adjustment continues until the transceiver 20 is put in a horizontal position. Now, the distance between the wall 90 and the object 91 can be measured. Thus, the length and width of a space can be measured.

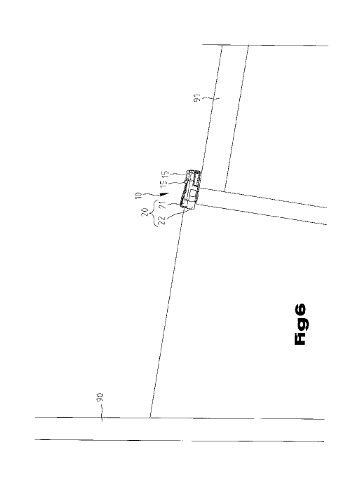

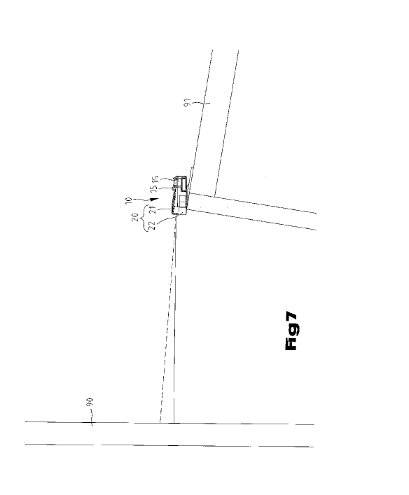

Referring to FIGS. 6 and 7, where it is impossible or difficult to adjust the position of the object 91, pads (not numbered) can be provided below the range finder in order to adjust the position of the range finder. The position of the range finder is adjusted while the spirit levels 15 are observed. The adjustment continues until the transceiver 20 is put in a horizontal position. Now, the distance between the wall 90 and the object 91 can be measured.

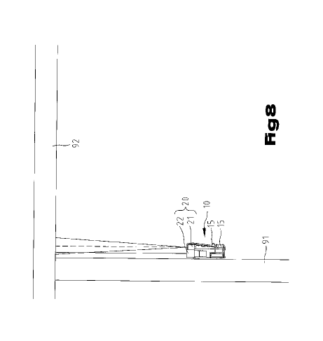

Referring to FIG. 8, where the object 91 is in a vertical position, the range finder is put against the object 91. The distance between a ceiling 92 and the object 91 can be measured. Thus, the height of a space can be measured. As discussed referring to FIGS. 5 through 8, the length, width and height of a space can be measured.

The present invention has been described through the description of the preferred embodiment. Those skilled in the art can derive variations from the preferred embodiment without departing from the scope of the present invention. Therefore, the preferred

What is claimed is:

1. A range finder comprising:
a housing comprising a first window defined therein, a second window defined therein and two fins formed thereon for contact with a first object, wherein a phantom line, in which the centers of the windows lie, is perpendicular to a plane defined by the fins;
two spirit levels installed on the housing so that they are perpendicular to each other;
a transceiver installed in the housing so that the transceiver can transmit laser to a second object through the first window and that the transceiver can receive light reflected from the object; and
a circuit board installed in the housing and electrically connected with the transceiver in order to receive data from the transceiver and determine the distance between the first and second objects based on the data.

2. The range finder according to claim 1 wherein the housing comprises a box and a panel installed on the box.

3. The range finder according to claim 2 wherein the second window is defined in the box.

4. The range finder according to claim 2 wherein the box comprises an ear formed thereon, wherein the panel comprises a recess defined therein for receiving the ear.

5. The range finder according to claim 4 wherein the first window consists of an aperture defined in the ear and an aperture defined in the panel within the recess.

6. The range finder according to claim 1 wherein the housing comprising a seat formed on an internal side for supporting the transceiver.

7. The range finder according to claim 1 wherein one of the spirit levels is used to determine a horizontal position of the laser range finder and the remaining spirit level is used to a vertical position of the laser range finder.

8. The range finder according to claim 7 wherein the panel comprises two seats formed thereon for supporting the spirit level.

9. The range finder according to claim 1 wherein the spirit level are parallel to the plane defined by the fins.

10. The range finder according to claim 1 wherein the housing comprises a battery chamber formed on an internal side thereof for receiving at least one battery.

11. The range finder according to claim 1 wherein the circuit board comprises a display for showing information, a microprocessor for processing the data and a switch operable for turning the circuit board on and off.

12. The range finder according to claim 11 wherein the housing defines a window through which the display can be observed.

13. The range finder according to claim 11 comprising a button installed on the housing and put in contact with the switch so that the switch is operable through the button.

14. The range finder according to claim 1 comprising a plurality of buttons installed on the housing and electrically connected with the circuit board so that the buttons are operable in order to control the circuit board.

15. The range finder according to claim 1 wherein the transceiver comprises a transmitter and a receiver connected with the transmitter.

16. The range finder according to claim 15 wherein the transmitter is integrated with the receiver so that the axis of the former is parallel to that of the latter.
